(19) United States
(12) Patent Application Publication
(10) Pub. No.: US 2014/0306646 A1
(43) Pub. Date: Oct. 16, 2014

(54) Wireless Charger

(71) Applicants: Wei-Ting Liu, Hacienda Height, CA (US); Wei-Hua Lu, Tucson, AZ (US); Chih-Kuei Hu, Tucson, AZ (US)

(72) Inventors: Wei-Ting Liu, Hacienda Height, CA (US); Wei-Hua Lu, Tucson, AZ (US); Chih-Kuei Hu, Tucson, AZ (US)

(21) Appl. No.: 13/844,882

(22) Filed: Mar. 16, 2013

(51) Int. Cl. H02J 7/02; H02J 7/00

(52) U.S. Cl. CPC H02J 7/025; H02J 7/0054; H02J 7/0047
USPC 320/103; 320/108

(57) ABSTRACT

The present invention discloses a portable device with a wireless power charger. The portable device can operate its normal function and provide wireless power to the other device at the same time. The present invention further discloses a portable device with a wireless power charger and a display which displays proposed direction or power related information. The present invention further discloses a portable device with a wireless power receiver and a display which displays proposed direction, power related information or positions of wireless power receiver and wireless power charger.

### BACKGROUND OF THE INVENTION

1. Field of the Invention

The present invention relates to a wireless charger and wireless power receiver, and more particularly, to a wireless charger and wireless power receiver with power transmission efficiency indicator.

2. Description of the Prior Art

The power supply for portable devices is very important. In the past, portable devices need to connect to power with real power lines. However, as more and more devices need to be connected together, such as monitor needs video line to connect with a computer, speakers need audio line to connect with a computer, network needs network line to connect with the computer and keyboard need keyboard line to connect with the computer, people tried to utilize wireless connection between devices. Nowadays even power supply for portable devices becomes wireless.

A typical electronic device with a wireless power supply is shown in FIG. 1. The electronic device 101 can be a cellular phone, digital camera, flat panel computer or other electronic device, which is put on a wireless charger 103 for receiving electric power. The wireless charger 103 has a power line 105 which connects to an electric outlet for receiving electric power.

### SUMMARY OF THE INVENTION

It is therefore a primary objective of the claimed invention to provide a portable device which can provide or receive wireless power, the portable device comprises a display; a wireless charger or receiver; a battery, for providing electric power to maintain operating function of the portable device; and a controller, for controlling the wireless charger or receiver; wherein the display provides a wireless power charging related message.

According to an objective of the present invention, the present invention discloses a portable device, comprises a display; a wireless charger, for providing wireless power; a battery, for providing electric power to maintain operating function of the portable device or to the wireless charger; and a controller, for controlling the wireless charger; wherein, the portable device is capable of operating its normal function and providing wireless power at the same time.

The present invention also discloses a portable device, comprises a display; a wireless power receiver, for receiving wireless power; a battery, for providing electric power to maintain operating function of the portable device; and a controller, for controlling the wireless power charging the battery; wherein, the display provides a wireless power charging related message in order to obtain a better wireless charging efficiency.

The present invention further discloses an electronic system comprises a first portable electronic device which comprises a first battery, for providing power to components of the first portable electronic device; a first wireless charger, capable of wirelessly transmitting a first power; and a first wireless power receiver, capable of wirelessly receiving a third power and storing the third power into the first battery; and a second portable electronic device which comprises a second battery, for providing power to components of the second portable electronic device; a second wireless charger, capable of wirelessly transmitting a second power; and a second wireless power receiver, capable of wirelessly receiving a fourth power and storing the fourth power into the first battery; wherein the third power comes from the second power, the fourth power comes from the first power, and first portable electronic device and the second portable electronic device wirelessly shares their energy with each other by transferring the first power or the second power to each other.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a portable device and a wireless charger according to the prior art.

FIG. 2 is a diagram showing a portable device with wireless power charger and a second device according to an embodiment of the present invention.

FIG. 3 shows a portable device with proposed direction on the display of the portable device according to an embodiment of the present invention.

FIG. 3-1 shows a new relative position of the portable device of FIG. 3.

FIG. 3-2 is an internal function block diagram of a portable device with wireless power charger and an internal function block diagram of a portable device receives wireless power according to an embodiment of the present invention.

FIG. 3-3 is an internal function block diagram of a portable device with wireless power charger and an internal function block diagram of a portable device receives wireless power according to another embodiment of the present invention.

FIG. 4 is a diagram showing a portable device receives wireless power and displays proposed direction.

FIG. 4-1 is a diagram showing a portable device receives wireless power and displays proposed direction and power related information.

FIG. 5 shows a portable device with movable wireless power charger and a portable device with movable wireless power receiver.

FIG. 6 shows a portable device on a plate with wireless power charger.

FIG. 7 is a diagram showing a portable device which displays wireless power charger position and wireless power receiver position.

FIG. 7-1 shows a portable device which displays wireless power charger position, wireless power receiver position and power related information; and a portable device which displays wireless power proposed direction and power related information.

### DETAILED DESCRIPTION

Although wireless charger for electronic device is available today, this kind of charger is dedicated to its device. In other words, user has to carry his charger when he is on business trip. If a user has many electronic devices, the user needs to carry many corresponding chargers with him.

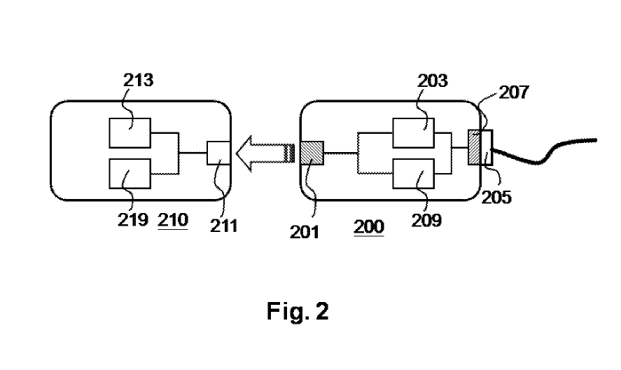

FIG. 2 shows a portable device 200 which comprises a power transmitter 201 embedded in this device. The portable device 200 can be a cellular phone, personal digital assistant (PDA), a digital camera or other portable device. The portable device 200 has its own traditional function, such as communication function, digital calendar function or camera function. Unlike traditional electronic device, this inventive portable device 200 can serve as an electric power provider without losing its traditional functions.

The portable device 200 comprises an electric power receiver 207 for receiving electric power from a power adapter 205 and a battery 209. The portable device 200 further comprises a controller 203 for controlling a power transmitter 201. The controller 203 can control how much power the power transmitter 201 needs to transmit, analyze charging responses such as parasitic metal object detection to avoid overheating or wasting power, and monitor whether the device is overheated or overloaded. The controller 203 can check whether the power adapter 205 is connected to the electric power receiver 207. If the connection is built, the controller 203 will allow the power transmitter 201 to transmit power to another device, a second device 210. The controller 203 can also check whether the power remain level in the battery 209 of the portable device 200 is higher than a first predetermined level. If the power remain level is higher than the first predetermined level, then the controller 203 will allow the power transmitter 201 to transmit power to the second device 210. However, if the power remain level is lower than a second predetermined level, then the controller 203 will cease the power transmitter 201 to transmit power to the second device 210. The first predetermined level and the second predetermined level can be two different levels or same level.

Similarly, the second device 210 comprises a wireless power receiver 211 for receiving wireless power. The second device 210 further comprises a controller 213 for controlling the wireless power receiver 211. The controller 213 can control whether the wireless power receiver 211 needs to receive wireless power, how much power the wireless power receiver 211 needs to receive, analyze power remain level of a battery 219 to avoid battery damage, overheating or wasting power, and monitor whether the device is overheated or overloaded. The controller 213 also checks whether the power remain level in the battery 219 of the portable device 210 is lower than a third predetermined level. If the power remain level is lower than the third predetermined level, then the controller 213 will allow the power receiver 211 to receive wireless power to the second device 210. However, if the power remain level is higher than a fourth predetermined level, then the controller 213 will cease the power receiver 211 to receive wireless power to the second device 210. The third predetermined level and the fourth predetermined level can be two different levels or same level.

In order to charge the second device 210 faster, the portable device 200 is capable of providing more than one power level to the second device 210. Taking two power levels as example, the portable device 200 provides a first power level wireless power and a second power level wireless power to the second device 210. The first power level is higher than the second power level. The controller 213 of the second device 210 will detect the power remain level of battery 219. If the power remain level of the battery is lower than a fifth threshold, the second device 210 will send out a signal to the portable device 200 and request a faster charging power. The portable device 200 receives the signal and transmits the wireless power of the first power level. If the power remain level of the battery is higher than a sixth threshold, the second device 210 will send out a signal to the portable device 200 and request a slower charging power. The portable device 200 receives the signal and transmits the wireless power of the second power level.

In another embodiment, even if the portable device 200 is not connected to the power adapter 205, the power transmitter 201 will also provide wireless power to the second device 210 in some situation. For example, if the power remain level of the second device 210 is very low, and the second device 210 needs to perform a very important work, the portable device 200 can transfer power to the second device 210. On the contrary, if the power remain level of the portable device 200 is also lower than a predetermined level, the power transmitter 201 will cease to provide wireless power.

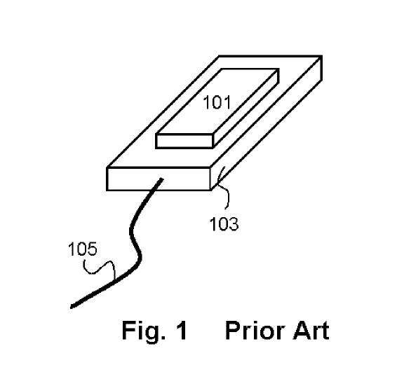

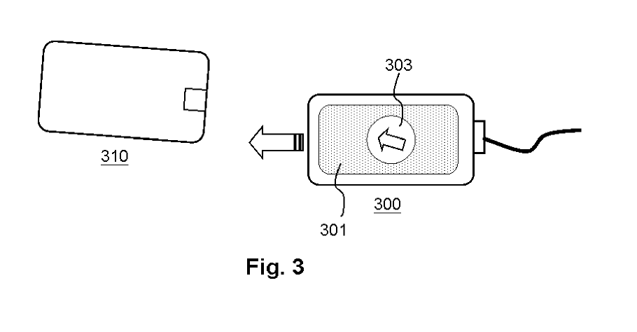

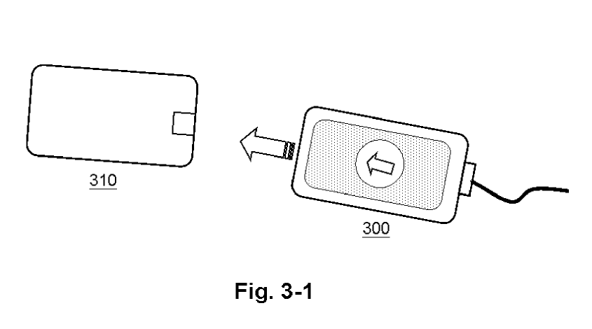

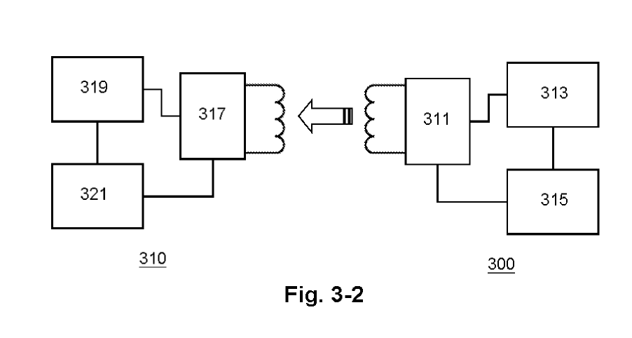

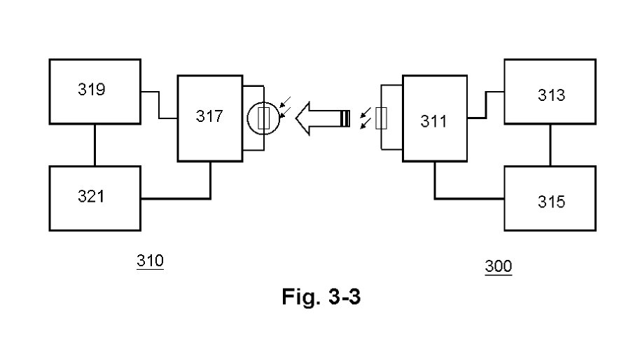

In order to obtain a better power transmission, the controller 203 will determine whether the relative positions between the portable device 200 and the power receiving device, the second device 210 is good enough. In FIG. 3, a portable device 300 comprises a display 301. When the portable device 300 is providing electric power to the other device, a second device 310, the display 301 will show a proposed direction 303 on the display. User can tilt the portable device 300 according to the proposed direction to obtain a better transmission rate. In FIG. 3-1, it shows a relative position between the portable device 300 and the second device 310 after the user changed the position of the portable device 300.

In FIG. 3-2, detailed structures of the portable device 300 and the other device, a second device 310 are shown. The portable device 300 comprises a power receiver 313, a controller 315 and a power provider 311. The power receiver 313 can be an AC to DC converter if the power receiver 313 receives an AC power directly. The power receiver 313 can also be a voltage regulator or a charge pump for providing a target voltage to the power provider 311. The power provider 311 can be a power driver for providing a magnetic field by current flowing through a coil in the power provider 311. In order to obtain better efficiency, designer can utilize mutually-attuned LC circuits to lower coefficient of coupling. The power provider 311 can also be a power driver for providing a rapidly alternating electrostatic field.

The second device 310 comprises a wireless power receiver 317, a voltage converter 319 and a controller 321. The wireless power receiver 317 receives the power sending from the portable device 300 and rectifies the form of power it received. The voltage converter 319 couples to the wireless power receiver 317, regulates the voltage it received and charges a battery in the second device 310. The controller 321 controls the wireless power receiver 317 and determines whether the wireless power receiver 317 needs to receive power. If the battery is already fully charged, the controller 321 will cease to receive power, and send a fully charged message to the portable device 300.

In FIG. 3-3, the power provider 311 can also provide electromagnetic radiation, microwave or laser to the wireless power receiver 317. The power provider 311 converts the power provided by the power receiver 313 into electromagnetic radiation, microwave or laser form. The wireless power receiver 317 can be an electromagnetic receiver, an antenna, a rectenna or photovoltaic cells. The wireless power receiver 317 receives the wireless power and converts the power into voltage or current form to the voltage converter 319, then charges the battery in the second device 310.

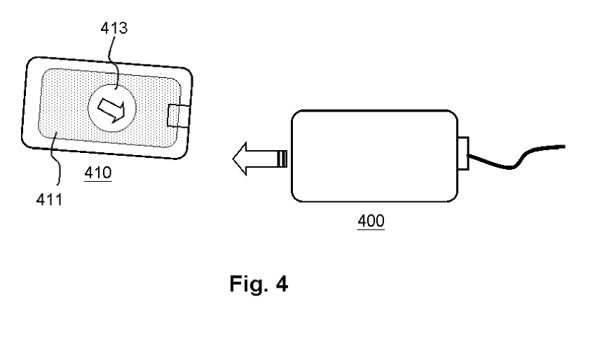

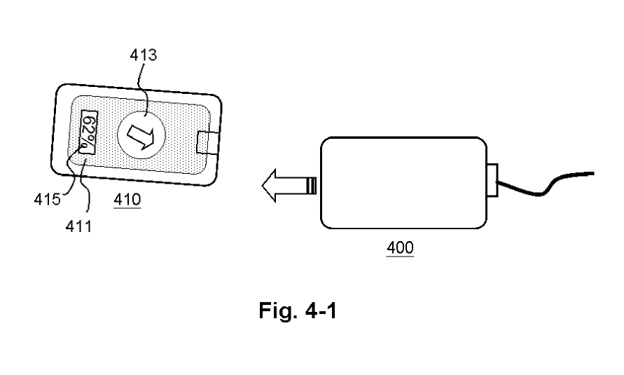

FIG. 4 shows another embodiment of this invention. In FIG. 4, a portable device 410 receives electric power from the other portable device, a third device 400. The portable device 410 comprises a display 411. In order to guide a user to adjust his portable device to a position for receiving more electric power, a proposed direction 413 is shown on the display 411. User can tilt his portable device 410 according to the proposed direction to obtain a better transmission rate. In FIG. 4-1, the portable device 410 further displays a message 415 to user for reference. The message could be an electric power percentage, which is the electric power received by the portable device 400 over the maximum electric power the portable device 410 can receive. The message could further be an electric power percentage, which is the electric power received by the portable device 400 over the electric power transmitted from the portable device 410. The portable device 400 can get the information of the electric power transmitted from the portable device 410 through a message sends from the portable device 410, an industrial protocol or standard. The message could also be an absolute electric power which the portable device 410 is receiving. The message could also be a voltage value which the portable device 410 is received, or a current value which the portable device 410 is received, or any information relating to power information. The message could also be a red/orange/green light wherein different light indicates different wireless power receiving status. For example, green light means good wireless power receiving status, orange means average status and red means poor status.

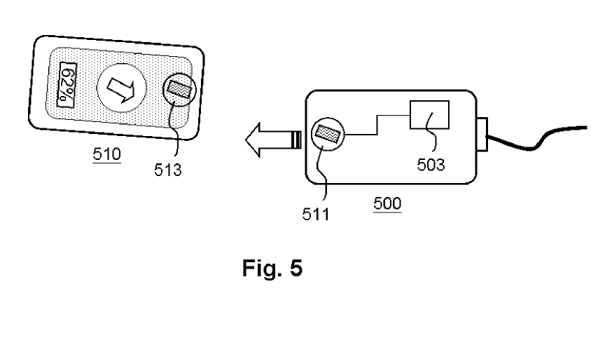

FIG. 5 shows another embodiment to realize a first portable device 500 transfers power to a second portable device 510 with better transmission rate. Unlike the previous method, the wireless power provider 511 can change its charging direction by itself. A controller 503 in the first portable device 500 will determine which direction is better for the second portable device 510 to receive more wireless power, and the controller 503 will move the wireless power provider 511 into the desired direction. The second portable device 510 can also has a wireless power receiver 513 which can change its power receiving direction by itself. A controller in the second portable device 510 will determine which direction is more efficient to receive wireless power, and change the direction of the wireless power receiver 513 into that direction.

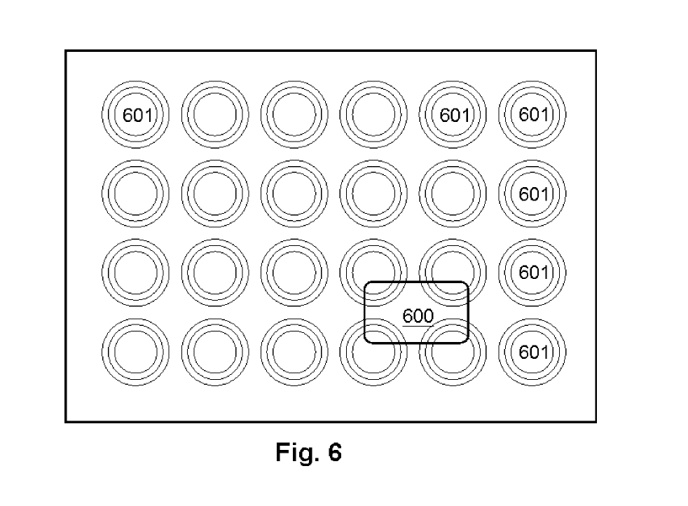

FIG. 6 shows a charging plate which can provide wireless power. This kind of plate could embed in furniture, coffee table, counter top etc. There are many electric charging coils 601 within the plate. However, in order to keep the plate's design or the plate's original appearance, the charging coils 601 are not visible. When a user puts his/her portable device 600 onto the plate for charging his/her portable device 600, he/she may put his/her portable device 600 on a relatively low charging rate position.

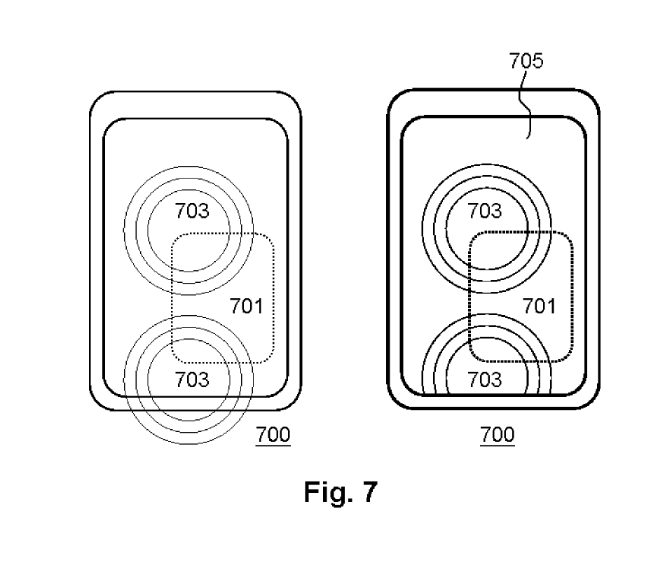

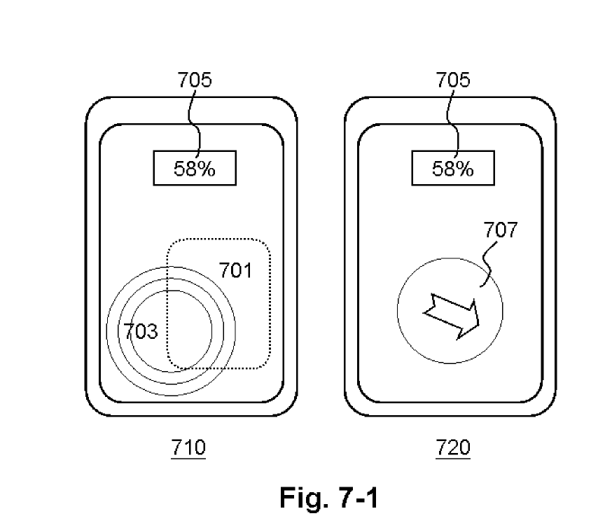

In FIG. 7, a portable device 700 comprises a wireless power receiver 701. When the portable device 700 is placed on a charging plate, the charging coils 703 are not fully overlapped with the wireless power receiver 701. In the case shown in the portable device 700, only upper left and lower left of the wireless power receiver 701 receives power, therefore the charging efficiency is relatively low. In order to obtain higher charging efficiency, the display 705 of the portable device 700 will show the position of the charging coils 703 and the position of the wireless power receiver 701 as shown in the right figure in FIG. 7. User can move his/her portable device 700 by referring to the relatively positions of the charging coils 703 and wireless power receiver 701 to receive more power.

The portable device can provide more information to user for reference. As shown in FIG. 7-1, the portable device 710 further provides a message 705 for user to reference. The message could be an electric power percentage, which is the electric power received by the portable device 710 over the maximum electric power the portable device 710 can receive. The message could further be an electric power percentage, which is the electric power received by the portable device 400 over the electric power transmitted from the portable device 410. The message could also be an absolute electric power which the portable device 710 is receiving. The message could also be a voltage value which the portable device 710 is received, or a current value which the portable device 710 is received, or any information relating to power information. The message could also be a red/orange/green light wherein different light indicates different wireless power receiving status. For example, green light means good wireless power receiving status, orange means average status and red means poor status.

The portable device could also show a suggested direction for user to move his/her portable device to receive more power. In FIG. 7-1, the portable device 720 displays a suggested direction 707 to user for reference. Although the portable device 720 only shows a suggested direction 707 and a power related message 705, and the portable device 710 only shows a power related message 705 and the relative positions of wireless power receiver 701 and charging coil 703, designer can combine or separate these items according to his design purpose, and these modifications will not escape the scope of this invention.

Those skilled in the art will readily observe that numerous modifications and alterations of the device and method may be made while retaining the teachings of the invention.

What is claimed is:

1. A portable device, comprising:
a display;
a wireless charger, for providing wireless power;
a battery, for providing electric power to maintain operating function of the portable device or to the wireless charger; and
a controller, for controlling the wireless charger;
wherein, the portable device is capable of operating its normal function and providing wireless power at the same time.

2. The portable device of claim 1, wherein the display displays a suggesting position to user for reference in order to obtain a better wireless charging efficiency.

3. The portable device of claim 1, wherein the wireless charger providing wireless power through magnetic field.

4. The portable device of claim 1, wherein the wireless charger providing wireless power through electromagnetic radiation, microwave or laser.

5. The portable device of claim 1, wherein the wireless charger is movable.

6. The portable device of claim 1, wherein if the portable device is being connected to an outside power source via a wire, the controller controls the wireless charger to automatically provide wireless power to an electronic device.

7. The portable device of claim 1, wherein the controller controls the wireless charger to provide wireless power according to a power remain level of the battery.

8. The portable device of claim 7, wherein if the power remain level is higher than a first threshold, the controller controls the wireless charger to provide wireless power.

9. The portable device of claim 7, wherein if the power remain level is lower than a second threshold, the wireless charger ceases to provide wireless power.

10. The portable device of claim 1, wherein the controller controls the wireless charger to provide wireless power to an electronic device to charge the electronic device if a power remain level of the electronic device is lower than a third threshold.

11. The portable device of claim 1, wherein the controller controls the wireless charger to cease to provide wireless power to an electronic device if a power remain level of the electronic device is higher than a fourth threshold.

12. The portable device of claim 1, wherein the wireless charger is capable of providing a first wireless power having a first power level or a second wireless power having a second power level, and the first power level is higher than a second power level.

13. The portable device of claim 12, wherein the controller controls the wireless charger to provide the first wireless power to an electronic device in order to quickly charge the electronic device if a power remain level of the electronic device is lower than a fifth threshold.

14. The portable device of claim 12, wherein the controller controls the wireless charger to provide the second wireless power to an electronic device in order to charge the electronic device if a power remain level of the electronic device is higher the sixth threshold.

15. The portable device of claim 14, wherein the electronic device displays a charging efficiency according to the power remain of the electronic device and a power level received by the electronic device.

16. The portable device of claim 1, wherein the electronic device displays a charging efficiency according to a power level received by the electronic device.

17. The portable device of claim 16, wherein the wireless charger provides wireless power having a power level to an electronic device, and the electronic device displays the charging efficiency according to a ratio of the power level of the wireless power and a power level received by the electronic device.

18. A portable device, comprising:
a display;
a wireless power receiver, for receiving wireless power;
a battery, for providing electric power to maintain operating function of the portable device; and
a controller, for controlling the wireless power charging the battery;
wherein, the display provides a wireless power charging related message in order to obtain a better wireless charging efficiency.

19. The portable device of claim 6, wherein the wireless power charging related message is a suggesting direction to user for reference.

20. The portable device of claim 6, wherein the wireless power charging related message is a wireless power related information.

21. The portable device of claim 8, wherein the wireless power related information is an electric power percentage.

22. The portable device of claim 8, wherein the wireless power related information is an absolute electric power which the portable device is received.

23. The portable device of claim 8, wherein the wireless power related information is a voltage or current value which the portable device is received.

24. The portable device of claim 6, wherein the wireless power charging related message is a charging coil location information.

25. The portable device of claim 6, wherein the wireless power charging related message is a wireless power receiver location information.

26. An electronic system comprising:
a first portable electronic device, comprising:
a first battery, for providing power to components of the first portable electronic device;
a first wireless charger, capable of wirelessly transmitting a first power; and
a first wireless power receiver, capable of wirelessly receiving a third power and storing the third power into the first battery; and
a second portable electronic device, comprising;
a second battery, for providing power to components of the second portable electronic device;
a second wireless charger, capable of wirelessly transmitting a second power; and
a second wireless power receiver, capable of wirelessly receiving a fourth power and storing the fourth power into the first battery;
wherein the third power comes from the second power, the fourth power comes from the first power, and first portable electronic device and the second portable electronic device wirelessly shares their energy with each other by transferring the first power or the second power to each other.
